(19) United States
(12) Patent Application Publication
(10) Pub. No.: US 2026/0204947 A1
(43) Pub. Date: Jul. 16, 2026

(54) AUXILIARY ENERGY SYSTEM, AND METHOD FOR PROVIDING AUXILIARY ENERGY

(71) Applicant: Siemens Energy Global GmbH & Co. KG, München (DE)

(72) Inventors: Erik Wolf, Röttenbach (DE); Christian Reller, Minden (DE)

(21) Appl. No.: 19/135,937

(22) PCT Filed: Nov. 21, 2023
(86) PCT No.: PCT/EP2023/082467

§ 371 Date: Jun. 5, 2025

(30) Foreign Application Priority Data
Dec. 16, 2022 (DE) 10 2022 213 780.9

(51) Int. Cl. H02J 15/50; F03D 9/00; F03D 9/19; H02J 3/38; H02J 101/24; H02J 101/28

(52) U.S. Cl. CPC H02J 15/50; F03D 9/007; F03D 9/19; H02J 3/38; F05B 2220/708; H02J 2101/24; H02J 2101/28

(57) ABSTRACT

The invention relates to an auxiliary energy system for a grid-independent operation of a renewable energy system. The auxiliary energy system is coupled to the renewable energy system and comprises a gas accumulator, wherein the auxiliary energy system is additionally designed to provide hydrogen (H₂) and oxygen (O₂), each of which is obtained from an electrolysis process, separately from each other in the gas accumulator, and the hydrogen (H₂) and/or the oxygen (O₂) from the system can be provided in variable proportions in the form of a gaseous auxiliary energy carrier in order to produce auxiliary energy (E, Eₜₕ). The invention additionally relates to a corresponding method for providing the auxiliary energy carrier for auxiliary energy (E, Eₜₕ), said auxiliary energy (E, Eₜₕ) being obtained as electric and/or thermal energy from the auxiliary energy carrier.

### BACKGROUND

The present invention relates to a system providing auxiliary energy for the grid-independent operation of a renewable energy system and to a method for providing auxiliary energy, in particular in the form of an auxiliary energy carrier.

Renewable energy systems, for example wind power systems, photovoltaic systems and/or solar thermal systems, are currently being developed largely for grid-independent operation. In particular, if the electricity supply is interrupted or is being interrupted, auxiliary energy must therefore be provided for these systems.

This auxiliary energy is required, e.g., to maintain the basic functions of the system, but also of associated ancillary systems or subcomponents. In particular in what is known as power-to-X systems or a coupling of renewable energy production and, e.g., (hydrogen) electrolyzers in terms of systems technology, there is a need for grid-independent (auxiliary) energy. Shorter supply interruptions, for example of a few hours, may be bridged with the aid of battery storage devices. However, in the event of prolonged downtimes of, for example, days and weeks, corresponding battery energy storage systems become uneconomical as a result of the high specific storage capacity costs of significantly more than €200 per kilowatt hour (kWh), for example in case of a Li-ion-based battery storage system (BESS).

As an alternative, energy storage systems based on hydrogen may be employed. The capacity costs of these storage devices are significantly lower and thus more economical. This type of energy storage becomes particularly attractive if the renewable energy system is coupled with a water electrolysis process.

### SUMMARY

It is therefore an object of the present invention to present, as an alternative to the battery solutions cited, an improved auxiliary energy concept and a method for providing corresponding auxiliary energy. In particular, it concerns the provision of auxiliary energy based on hydrogen and/or oxygen.

This object is achieved by the subject of independent claims. Advantageous embodiments are the subject of dependent claims.

One aspect of the present invention thus relates to an auxiliary energy system for the grid-independent operation of a renewable energy system, wherein the auxiliary energy system is coupled to the renewable energy system, i.e., for example, interconnected thereto in terms of systems technology. For example, corresponding (electric) auxiliary energy, but also further functions of the proposed system, may be passed on to the renewable energy system via this coupling.

The auxiliary energy system additionally comprises a gas accumulator and is designed to provide or retain, respectively, hydrogen and oxygen, each of which is preferably obtained from an electrolysis process, in particular (pressure-operated) water-PEM electrolysis process, separately from each other in the energy storage device. The system is additionally designed to provide hydrogen and/or oxygen in variable proportions in the form of a gaseous auxiliary energy carrier in order to produce auxiliary energy.

According to the present invention, the auxiliary energy carrier is characterized in particular in that hydrogen and oxygen are provided in arbitrary (stoichiometric) proportions adapted to the application needs, possibly with additional blending of ambient air. This in turn advantageously promotes the efficiency and thus the energy efficiency of downstream catalytic processes or combustion processes which may provide thermal and/or electric auxiliary energy, for example for the renewable energy system.

In one embodiment, the gas accumulator comprises a gas pressure tank for hydrogen and a separate gas pressure tank for pure oxygen. These gases may expediently be obtained from an electrolysis process and (temporarily) stored before both gases are provided in predetermined proportions according to the invention, for example for combustion or as a reaction mixture.

In one embodiment, the system comprises a gas mixing apparatus additionally configured to provide the hydrogen and the oxygen from the system in variable proportions in order to produce auxiliary energy. In this way, in particular, external mixture formation adapted to the needs may already occur for a downstream catalytic and/or oxidative reaction or reconversion of the energy carrier into electricity.

In one embodiment, the auxiliary energy system comprises the electrolysis system described.

The variant explained further below of admixing ambient air in likewise arbitrary proportions advantageously makes it possible to perform the downstream process—whether as a combustion, catalysis or other electrification or use—particularly energy-efficiently and also in accordance with safety regulations. A particular advantage of the use of a pure or low-ambient-air hydrogen-oxygen mixture is that, as a result of the increased oxygen content, compared to blending with ambient air, in a downstream combustion system for the reconversion into electricity, fewer emissions may arise or the combustion may occur in a significantly more efficient way, respectively.

In one embodiment, the auxiliary energy system is a functional part of the renewable energy system cited, such as, for example, of a wind power system and/or of a photovoltaic system, which is to be appropriately supplied with auxiliary energy for a grid-independent operation via the proposed solution.

A wind power system requires such auxiliary energy, for example, for open-loop control, closed-loop control, for a rotor brake or other safety systems, but also for position lights and corresponding climate control.

In one embodiment, the gas accumulator of the auxiliary energy system is integrated, for example, with a wind power system or a solar thermal system as a renewable energy system in a load-bearing manner and/or providing a counterweight. As a result of this embodiment, the auxiliary energy system may advantageously adopt functional tasks of the energy system in addition to the supply of energy.

A further aspect of the present invention relates to a method for providing or using, respectively, the auxiliary energy carrier or the auxiliary energy, respectively, wherein the auxiliary energy—additionally as an alternative to emergency generators or battery storage devices—is obtained or provided, respectively, from the auxiliary energy carrier in variable proportions as electric and/or thermal energy.

In one embodiment, the auxiliary energy is used as thermal energy for controlling the temperature of the electrolysis process or of a correspondingly coupled electrolysis system, respectively.

In one embodiment, the waste heat may advantageously be leveraged for maintaining the temperature or for preheating during start-up of the system in order to significantly shorten the start-up time, for example by hours in case of alkaline electrolysis.

In one embodiment, the (thermal) auxiliary energy is provided or obtained via a catalytic reaction, for example via a flameless combustion by means of a catalyst.

In a further embodiment, the auxiliary energy is released via an oxidation process of hydrogen by means of oxygen or is provided in this way, respectively.

In one embodiment, the auxiliary energy carrier—for example, in case of a grid-independent auxiliary energy demand of the system—is reconverted into electricity or re-electrified, respectively, via a (in particular hydrogen/oxygen) fuel cell, a gas turbine or a gas engine, respectively. By means of the proportion of oxygen in the reaction mixture which is variable or tailored, respectively, as a result of the present invention, it is possible in particular to operate the gas turbine or the gas engine, respectively, with a higher energy density or energy yield, respectively.

In one embodiment, the auxiliary energy carrier is provided with oxygen—with or without admixture of ambient air—in proportions of between 10% and 100% and (corresponding) residual constituents of hydrogen.

In one alternative embodiment, the auxiliary energy carrier is provided with oxygen—with or without admixture of ambient air—in proportions of between 50% and 100% and (corresponding) residual constituents of hydrogen.

In one alternative embodiment, the auxiliary energy carrier is provided with oxygen—with or without admixture of ambient air—in proportions of between 10% and 80% and (corresponding) residual constituents of hydrogen.

In one embodiment, the auxiliary energy is supplied directly via the paths cited to a combustion reaction for reconversion into electricity or re-electrification, respectively.

In one alternative embodiment, the auxiliary energy carrier is supplied to a combustion reaction for reconversion into electricity with prior admixture of additional ambient air.

In one embodiment, the auxiliary energy is additionally utilized or used, respectively, for product synthesis, such as a methanation system, a system for the synthesis of methane or methanol, an ammonia synthesis system and/or a gas liquefaction process, or further industrial processes.

Embodiments, features and/or advantages presently concerning the auxiliary energy system likewise relate to the method for providing the auxiliary energy, and vice versa.

As used herein, the term “and/or” or “respectively” when employed in a series of two or more elements means that each of the elements listed may be used individually, or any combination of two or more of the elements listed may be used.

### BRIEF DESCRIPTION OF THE DRAWINGS

Further details of the invention are described hereinafter with reference to the figures.

FIG. 1 shows, with reference to a simplified diagram, method steps according to the invention and an auxiliary energy system according to the invention.

In the exemplary embodiments and figures, identical or identically acting elements may each be provided with the same reference symbols. The elements depicted and their sizes relative to one another are not to be regarded as true to scale; rather, individual elements may be depicted in exaggerated thickness or large dimensions for better visualization and/or for better understanding.

### DETAILED DESCRIPTION

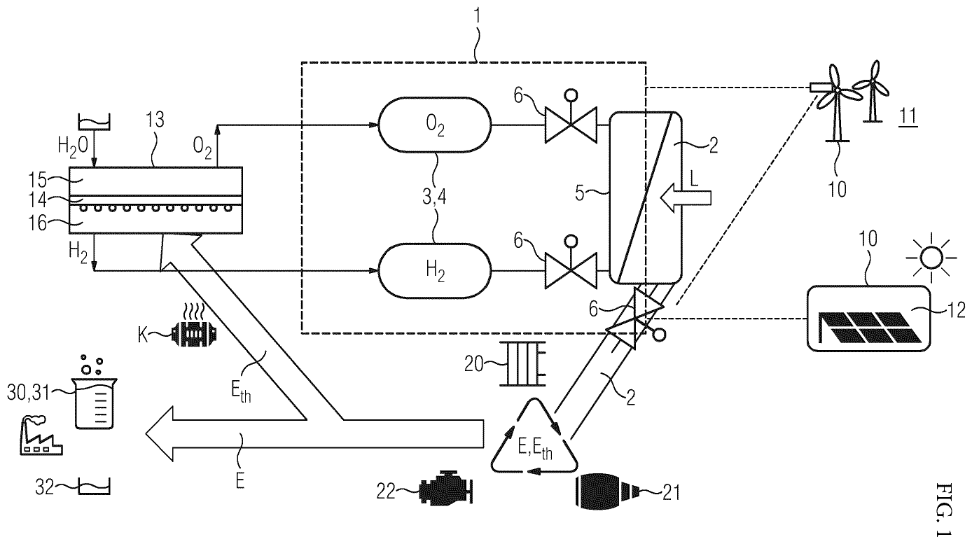

FIG. 1 shows, with reference to a technical flow diagram, an auxiliary energy system according to the invention and, inter alia, its functional coupling to an electrolysis system 13 and to a renewable energy system 10.

The auxiliary energy system 1 according to the invention (presently identified by the dashed rectangle) is coupled, in particular, to the renewable energy system 10 for the grid-independent operation. The auxiliary energy system 1 comprises a gas accumulator 3. The gas accumulator 3 additionally comprises a gas pressure tank 4 for (pure) hydrogen H₂ and a separate (identical) gas pressure tank 4 for pure oxygen O₂. Accordingly, the auxiliary energy system 1 is designed to provide hydrogen H₂ and oxygen O₂, each of which is obtained from an electrolysis process (cf. system correspondingly indicated with the reference symbol 13), separately from each other in the gas accumulator 3.

The correspondingly retained hydrogen H₂ and/or oxygen O₂ may advantageously be retained from the system 1 in variable proportions in the form of a gaseous auxiliary energy carrier 2 in order to produce auxiliary energy E, Eₜₕ, in particular for the renewable energy system 10 and/or for further processes or purposes.

The auxiliary energy system 1 additionally comprises, for the provision of the auxiliary energy carrier 2 in variable proportions of the hydrogen H₂ and the oxygen O₂, a gas mixing apparatus 5 or a gas accumulator 3 for a corresponding gas mixture, which is designed to provide both gases from the system 1 in order to produce auxiliary energy E, Eₜₕ, in particular for later reconversion into electricity independently of needs. Technical advantages according to the invention result directly therefrom due to an increase in the efficiency of a combustion reaction performed for electrification.

For this purpose, the system 1 may have, for example, one or more (partial) gas pressure control valves 6.

The electrolysis system 13 is preferably a water/hydrogen electrolysis process, in particular a water-PEM (“proton exchange membrane” or “polymer electrolyte membrane”, abbreviated to “PEM”) electrolysis process. In this variant, an embodiment as pressure-operated PEM electrolysis is more preferred since the gases arising may be stored in a simplified and more efficient manner in this way. Alternatively, the electrolysis system may be an alkaline electrolysis system.

By way of example only, FIG. 1 therefore shows a PEM electrolysis “stack” having a membrane 14 and an anode 15 above it and a cathode 16 (at the bottom) via which the hydrogen H₂ may be obtained and output to the auxiliary energy system 1 or supplied to it. At the anode 15, reagent water (H₂O) is supplied and oxygen O₂ is correspondingly discharged for output to the system 1.

In the right-hand part of the depiction of FIG. 1, the renewable energy system 10 is sketched in particular. The system 10 may be a wind power system 11 or, alternatively, a photovoltaic system 12. Without restricting the general nature, the renewable energy system 10 may also be a solar thermal system in order to produce renewable energy or a comparable system.

As implied by the dashed lines, the auxiliary energy system 1 may be, for example, a functional part of the renewable energy system 10. That is, in addition to the grid-independent energy supply of the energy system 10, such as, for example, for its basic or ancillary functions, the system 1 is in addition preferably coupled to the system 10 such that at least the gas accumulators 3 in the structure of the system 10 act, for example, in a load-bearing manner, a stabilizing manner and/or providing a counterweight. In case of a wind power system 11, the system 1 may be attached, for example, in the tower or in the generator nacelle opposite the rotor. The system 1 may be associated with the wind power system 11 generally directly, but also indirectly, e.g., on a platform.

Additionally, a method for operating the auxiliary energy system 1 described with reference to FIG. 1 or, respectively, a corresponding method for providing the auxiliary energy E, Eₜₕ cited in the form of the auxiliary energy carrier 2 comprising the oxygen O₂ and/or hydrogen H₂ cited, is a subject of the present invention.

For this purpose, as implied in the lower part of FIG. 1, the auxiliary energy may be obtained, for example, as electric auxiliary energy and/or as thermal energy Eₜₕ from the auxiliary energy carrier 2.

The flow arrow identified by Eₜₕ is intended to imply that the method relates to the use of the auxiliary energy as thermal energy, for example for controlling the temperature of the electrolysis process, in particular in the electrolysis system 13. In particular in case of alkaline electrolysis, it is necessary for the electrolysis system to be externally temperature-controlled in order to maintain the system at operating temperature (for example 60° or more) or also in order to make a cold start as efficient as possible.

Alternatively, or in addition, in the course of the proposed method, the auxiliary energy Eₜₕ may be provided via a catalytic reaction K, for example by means of a flameless combustion via a catalyst containing platinum, rhodium or palladium for providing thermal energy. This embodiment(s) is implied by the reference symbol K in the left-hand region of the depiction, where the thermal energy Eₜₕ is returned to the electrolysis system 13 for the purpose described.

In general, according to the invention, the auxiliary energy may be released or provided, respectively, via an oxidation process of hydrogen H₂ by means of oxygen O₂.

In case of a grid-independent energy demand of the renewable energy system 10, the auxiliary energy carrier 2 may appropriately be reconverted into electricity via a fuel cell 20, a gas turbine 21 and/or a gas engine 22. For this purpose, the gas engine 22 or the gas turbine 21 may comprise, for example, an external gas treatment or a direct injection. The fuel cell 20 may correspondingly be an “air-breathing” fuel cell or a pure hydrogen/oxygen fuel cell. In any case, the solution according to the invention of, inter alia, (partial) substitution of conventionally supplied ambient air by pure oxygen O₂ leads to an oxygen content which is advantageously increased—as compared with the prior art—and thus to an increase in efficiency and general improvement of the auxiliary energy system.

For example, the method described may provide the auxiliary energy carrier 2 with oxygen O₂ in proportions of between 10% and 100% and residual constituents of hydrogen H₂. In particular, the auxiliary energy carrier 2 may accordingly also comprise an oxygen content of between 50 and 100%, likewise advantageously between 10% and 50% or between 10% and 80%, specifically with or without admixture of ambient air L—and (corresponding) residual constituents of hydrogen.

Hence, the auxiliary energy carrier 2 may either be directly supplied to a combustion reaction for reconversion into electricity or this happens with prior admixture of additional ambient air L (cf. arrow pointing to the left).

In principle, the gas mixture for combustion in case of the gas engine as well as in case of the fuel cell may be such that the oxygen gas is made available to the combustion system with or without prior blending with ambient air. For this purpose, the corresponding heat engine may be equipped—depending on whether it is fitted with or without air admixture—for example as a direct injection without additional gas treatment or with a device for external mixture formation. The fuel cell may correspondingly be an “air-breathing” fuel cell or a pure hydrogen/oxygen fuel cell.

At the bottom left of FIG. 1, it is also implied that, in particular, electric auxiliary energy E may additionally be used by means of the method described either for electrically operated ancillary systems of the renewable energy system 10, or also for further industrial processes, for example for a product synthesis process, such as a methanation system 30, an ammonia synthesis system 31 and/or a gas liquefaction process 32.

In this respect, it is also provided that such downstream processes are interconnected and/or coupled to the auxiliary energy system 1 and/or the renewable energy system 10 in terms of systems technology.

Essentially, the present invention may be described or outlined, respectively, in the following words: The electrolytically produced hydrogen H₂ and oxygen O₂ are stored or retained in separate storage tanks 4 and, if needed, reconverted into electricity or (re-)electrified via a fuel cell 20 or gas engine 22 or gas turbine 21. The possibility of supplying oxygen O₂ as an oxidizing agent to the process and thus improving the efficiency and power density is beneficial in terms of efficiency. The oxygen O₂ may be added to the combustion or reaction air or may completely replace it, respectively—as in the case of an oxygen-hydrogen fuel cell. The waste heat generated may be utilized to maintain the temperature of the water electrolysis process and thus significantly shorten the start-up time of the system. Furthermore, the auxiliary energy may be used to operate processes which are technically very complex and disadvantageous to interrupt.

1. An auxiliary energy system for a grid-independent operation of a renewable energy system wherein the auxiliary energy system is coupled to the renewable energy system and comprises a gas accumulator, wherein the auxiliary energy system is additionally designed to provide hydrogen (H₂) and oxygen (O₂), each of which is obtained from an electrolysis process, separately from each other in the gas accumulator and the hydrogen (H₂) and/or the oxygen (O₂) from the system can be provided in variable proportions in a form of a gaseous auxiliary energy carrier in order to produce auxiliary energy (E, Eₜₕ).

2. The system according to claim 1, wherein the gas accumulator comprises a pressure tank for hydrogen (H₂) and a separate pressure tank for pure oxygen (O₂).

3. The system according to claim 1, comprising a gas mixing apparatus designed to provide the hydrogen (H₂) and the oxygen (O₂) from the system in variable proportions in order to produce auxiliary energy (E, Eₜₕ).

4. The system according to claim 1, wherein the auxiliary energy system is a functional part of the renewable energy system, such as, for example, of a wind power system and/or of a photovoltaic system, in particular to ensure its energy supply for a grid-independent operation.

5. The system according to claim 4, wherein the gas accumulator of the auxiliary energy system is integrated with a wind power system as a renewable energy system in a load-bearing manner and/or providing a counterweight.

6. A method for providing an auxiliary energy carrier for auxiliary energy (E, Eₜₕ) by means of an auxiliary energy system of any one of the preceding claims, said auxiliary energy (E, Eₜₕ) being obtained as electric and/or thermal energy from the auxiliary energy carrier.

7. The method according to claim 6, wherein the auxiliary energy is used as thermal energy (Eₜₕ) for controlling a temperature of an electrolysis process in an electrolysis system.

8. The method according to claim 6, wherein the auxiliary energy (Eₜₕ) is provided via a catalytic reaction (K).

9. The method according to claim 6, wherein the auxiliary energy (Eₜₕ) is released or provided, respectively, via an oxidation process of hydrogen (H₂) by means of oxygen (O₂).

10. The method according to claim 9, wherein the auxiliary energy carrier, for example in case of a grid-independent energy demand of the renewable energy system, is reconverted into electricity via a fuel cell (20), a gas turbine and/or a gas engine.

11. The method according to claim 6, wherein the auxiliary energy carrier is provided with oxygen (O₂) in proportions of between 10% and 100% and residual constituents of hydrogen (H₂).

12. The method according to claim 6, wherein the auxiliary energy carrier is either directly supplied to a combustion reaction for reconversion into electricity or this occurs with prior admixture of additional ambient air (L).

13. The method according to claim 6, wherein the auxiliary energy (E, Eₜₕ) is additionally utilized for a methanation system, an ammonia synthesis system and/or a gas liquefaction process.
